(19) United States
(12) Patent Application Publication
(10) Pub. No.: US 2026/0133022 A1
(43) Pub. Date: May 14, 2026

(54) DENDROMETER

(71) Applicant: Oregon State University, Corvallis, OR (US)

(72) Inventor: John Selker, Corvallis, OR (US)

(73) Assignee: Oregon State University, Corvallis, OR (US)

(21) Appl. No.: 19/375,092

(22) Filed: Oct. 30, 2025

Related U.S. Application Data
(60) Provisional application No. 63/720,127, filed on Nov. 13, 2024.

(51) Int. Cl. G01B 5/00

(52) U.S. Cl. CPC G01B 5/0035

(57) ABSTRACT

A dendrometer, comprising a single mechanical element functionally holds a sample under test via a spring-element in the element that draws two arms firmly against the sample. The spring section of the single mechanical element can be serpentine, or any other shape providing the desired spring constant and range of motion. The one or more spring members extend between the first frame member and the second frame member, wherein the one or more spring structures are nonrigid (extensible and compressible) such that the second frame member is movable relative to the first frame member. The dendrometer comprises a toothed socket on an end of each arm to allow adjustment of the range of clamping. In at least one example, a magnet or actuator attached to one arm, and a Hall effect or other positional sensor, is attached to the alternate arm.

### CLAIM OF PRIORITY

This application claims priority to U.S. Provisional Ser. No. 63/720,127, filed Nov. 13, 2024, titled “Dendrometer,” which is incorporated by reference in its entirety for all purposes.

### BACKGROUND

Dendrometers are field devices used in ecology, forestry, agriculture and horticulture for scientific measurement of growth of fruit and tree limbs. The measurements reveal daily, seasonal, and year-to-year variations in growth and water stress which is ever more important as hotter and dryer climates develop around the world in concert with growing demands on finite water resources. They are employed by attaching to individual fruits and/or limbs on one or many trees and bushes for monitoring overall growth rates and diurnal cycles of expansion and contraction. Dry and wet conditions contribute to overall fruit or branch growth rates, which can indicate when trees may need more or less water, when fruits are close to being harvest-ready, etc.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical embodiments can only approximate illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1 illustrates a profile view of a first embodiment of a dendrometer assembly, in accordance with at least one example.

FIG. 2 illustrates a profile view of a second embodiment of a dendrometer assembly, in accordance with at least one example.

FIG. 3A illustrates an end-on profile view oriented in the x-z plane of lower clamp member having a trough for attachment to limbs, in accordance with at least one embodiment.

FIG. 3B illustrates a frontal view oriented in the y-z plane of lower clamp member having a trough for attachment to limbs, in accordance with at least one example.

FIG. 3C illustrates a frontal view oriented in the y-z plane of lower clamp member having hemispherical cup attachment for fruits, in accordance with at least one example.

FIG. 3D illustrates a side profile view oriented in the x-z plane of lower clamp member having a hemispherical cup attachment for fruits, in accordance with at least one example.

FIG. 4A illustrates a frontal profile view in the x-z plane of toothed peg, in accordance with at least one example.

FIG. 4B illustrates a side profile view in the y-z plane of toothed peg, in accordance with at least one example.

FIG. 5 illustrates a system comprising a dendrometer assembly shown in FIG. 1, in accordance with at least one example.

FIG. 6 illustrates a sensor network that the dendrometer uses to transfer data, in accordance with at least one example.

FIG. 7 illustrates an electronic system with a schematic of data logger for a magnetic positional sensor and a light emitting diode (LED) indication system, in accordance with at least one example.

FIG. 8 illustrates a process flow chart for operating a dendrometer assembly according to at least one example.

FIG. 9 illustrates a processor system with a machine-readable storage medium having machine-readable instructions that when executed cause a circuit board of a control unit of the system, to execute machine-readable instructions according to the method summarized by the method summarized in FIG. 8, in accordance with at least one example.

### DETAILED DESCRIPTION

In many instances, individual dendrometers deployed in the field are wired or connected with short-range radios to a central telemetry transmitter, wherein growth data may be sent wirelessly to a central database multiple times per day. As dendrometers are used in the field, they are made to measure changes in fruit diameter or branch diameter of several tens of microns per day. Thus, high measurement sensitivity, precision and accuracy are important design considerations. Dendrometers on the market today are generally delicate instruments. Many use linear variable placement transducer (LVPT) types of sensors for measurements, others use strain gauges for measuring growth of both fruits and tree limbs or trunks. LVPT transducers are sensitive to temperature fluctuations, have internal friction which gives rise to mechanical hysteresis, and have limited accuracy. Most stain gauges have problems with temperature dependence, and place stress on delicate fruits. In addition, strain gauges are difficult to miniaturize, limiting applicability for measuring small and delicate fruits, such as for grapes and berries. Many commercial dendrometers are made from multiple parts that may have different thermal expansion coefficients and are made from materials that have high coefficients of expansion as well. Thus, measurement accuracy may be obscured by thermally-induced dimensional changes of the frame of the device which are exactly in phase with the critical measurement data, thereby deeply complicating interpretation of the output of these devices. Moreover, these devices may be easily misaligned by being jostled (e.g., by an animal, by wind or a storm), thus calling into question the reliability of the measurement. A more reliable, simple to use, zero friction, thermally stable dendrometer design is called for.

Described herein is a dendrometer having a unitary body design, comprising one contiguous part. In some embodiments, the disclosed dendrometer comprises a magnetic hall effect sensor to measure dilations and contractions of fruits or tree limbs on the order of one micron per day. In some embodiments, the dendrometer comprises two frame members that are coupled together by a central member comprising one or more non-rigid spring-like serpentine sub-members extending between the first frame member and the second frame member. The serpentine or other spring-geometry sub-members are unitary with the first and second frame members and are made from the same material as the frame members. Adjustment of the opening of the device is useful to accommodate a variety of sample sizes. This is exemplified here by making the first frame member comprise a toothed socket at one end. The toothed socket comprises a slot extending the length of the toothed socket, wherein two opposing sidewalls of the slot comprise a series of triangular or other shaped teeth extending from a first open end to a second closed end of the slot. In some embodiments, a mating peg fits into the slot and has identically shaped and dimensioned teeth to mesh with the teeth in the slot of the toothed socket. The mating peg is configured to carry to hemispherical cup or V-shaped adapter to fit on a part of a fruit or a limb. The toothed socket aids in accurately fitting the cup or adapter on a fruit or a tree limb by providing an adjustable fixture for the mating peg, whereby the peg may be pressed into the toothed slot and meshing the teeth together. Similar adjustability could be achieved by threads, multiple holes and securing screws to fix the holder at various distances, etc. While various examples are illustrated with reference to a fruit or a tree limb, the examples can be applied to any object such as a tube, hose, ball, etc.

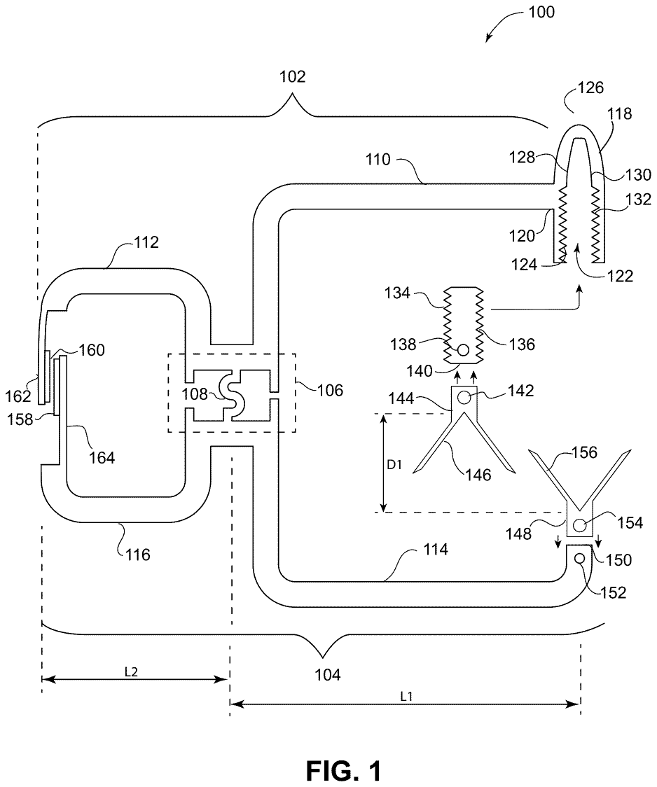

FIG. 1 illustrates a profile view of dendrometer assembly 100, in accordance with at least one embodiment. In some embodiments, dendrometer assembly 100 comprises a unitary frame body, wherein the unitary frame body comprises frame member 102 and opposing frame member 104. Frame member 102 and frame member 104 are coupled together by serpentine (e.g., S-shaped) member 106. In some embodiments, serpentine member 106 comprises at least one nonrigid, spring-like serpentine structure 108 that is a nonrigid, extensible/compressible structure intended to compress, flex and bend according to forces imposed on frame members 102 and 104. While serpentine member 106 is shown to have one or more serpentine structures 108 in the illustrative embodiment of FIG. 1, in other embodiments any number of serpentine structures 108 may be present. In some embodiments, serpentine structure 108 is unitary and contiguous with frame members 102 and 104, with no seam or boundary between the three portions of the unitary frame body. In some embodiments, the unitary frame body may be manufactured by additive processes, such as 3D printing or injection molding, or by subtractive processes such as milling. In some embodiments, the unitary frame body comprising frame members 102 and 104 and serpentine member 106 comprise a single material. For example, frame members 102 and 104, as well as serpentine member 106 comprise the same carbon fiber composite. Differential temperature expansion effects are minimized by use of a unitary body design, where all members of the unitary frame body are made of the same material and composition.

In at least one embodiment, frame member 102 comprises forward arm 110 and rear arm 112, where serpentine member 106 forms a fulcrum, junction, or pivot point between forward arm 110 and rear arm 112. Frame member 104 is configured to tilt about serpentine member 106. Similarly, frame member 104 comprises forward arm 114 and rear arm 116. In some embodiments, forward and rear arms extend in opposite directions from one another. Again, serpentine member 106 acts as a fulcrum, junction or pivot point between forward arm 114 and rear arm 116. Overall, serpentine member 106 permits frame member 102 to be movable relative to frame member 104. In some embodiments, toothed socket 118 extends from a distal end 120 of forward arm 110. Toothed socket comprises slot 122 that extends along an axis of toothed socket 118, from an open end 124 of toothed socket 118 to a blind end 126. In some embodiments, slot 122 is an open structure, having a rectangular cross section and comprising two opposing sidewalls, sidewall 128 and 130. Slot 122 has a thickness extending into the plane of the figure approximately the thickness of the frame body. In some embodiments, at least a portion of sidewalls 128 and 130 have teeth 132 that may be triangular, as shown, or rectangular or round.

In at least one embodiment, toothed peg 134 is a detachable part of dendrometer assembly 100, configured to mate with toothed socket 118. Toothed peg 134 comprises two opposing sidewalls having rows of teeth 136 on each sidewall, like teeth 132 within slot 122 of toothed socket 118. Teeth 136 of toothed peg 134 are configured to insert into slot 122 of toothed socket 118, whereby teeth 136 are to engage and mesh with teeth 132 on the inside sidewalls 128 and 130 of toothed socket 118. In some embodiments, toothed peg 134 comprises pin 138 near distal end 140. Pin 138 may be configured to fit into hole 142 of clamp member 144, to allow upper clamp member 144 to be suspended from tooth peg 134. Upper clamp member 144 comprises a cup or V-shaped trough 146 that is configured to fit over a fruit or tree limb, respectively. In the illustrative embodiment, upper clamp member 144 is configured to attach to tree limbs using a V-shaped trough 146. A cup-shaped clamp member may be configured to fit over a round fruit. In some embodiments, toothed socket 118 comprises open end 124 that faces distal end 150 of forward arm 114 to allow alignment of upper clamp member 144 with a lower clamp member 148 (described below).

By way of teeth 136 and 132, toothed peg 134 may be inserted within slot 122 of toothed socket 118 and its amount of protrusion from open end 124 of toothed socket 118 may be finely adjusted. Protrusion of toothed peg 134 from toothed socket 118 can enable distance adjustment between clamp member 144 and clamp member 148, the two structures that are attached to a fruit or limb. To adjust for size of various fruits or limbs, distance D1 between upper and lower clamp members 144 and 148 may be adjusted by placement of toothed peg 134 at different positions within toothed socket 118. Pitch of teeth 132 and 136 may be adjusted to provide a predefined fine adjustment of the distance between upper and lower clamp members 144 and 148, respectively.

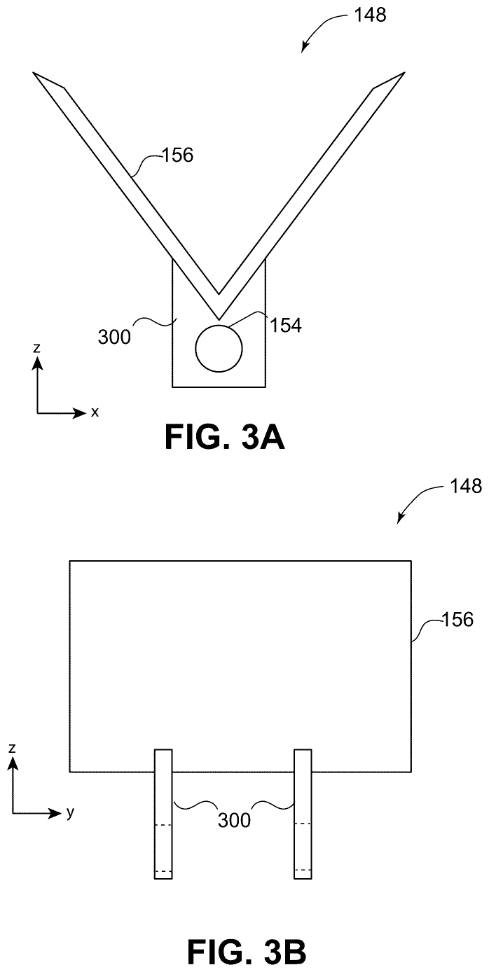

In some embodiments, lower clamp member 148 attaches to distal end 150 of forward arm 114 of frame member 104 by pressing pin 152 through hole 154. While upper and lower clamp members 144 and 148 are configured as troughs 146 and 156, they may be configured as hemispherical structures that fit over round fruits (for example, see FIGS. 3C and 3D). The size of upper and lower clamp members, as well as the unitary frame body, may be sized to fit certain types of fruits or limbs.

In some embodiments, magnetic positional sensor 158 and magnet 160 are attached near distal ends 162 and 164 of rear arms 112 and 116, respectively. In some embodiments, rear arms 112 and 116 have a C-shape so that distal ends 162 and 164 overlap, allowing magnetic positional sensor 158 to be positioned adjacent to magnet 160, while maintaining a gap of suitable size between the magnet and sensor. When measuring growth or contraction, forward arms 110 and 114 move toward or away from one another, respectively. The movement causes rear arms 112 and 116 to have a scissor-like movement as frame members 102 and 104 rock about serpentine member 106. The scissoring motion causes magnet 160 and magnetic positional sensor 158 to slide past each other. The sliding motion is detected as positional changes of magnet 160 by magnetic positional sensor 158. For example, magnetic positional sensor 158 is a hall effect sensor. As such sensors are sensitive to small changes in magnetic fields, positional changes of magnet 160 on the order of microns are measurable by magnetic positional sensor 158.

This resolution of magnetic positional sensor 158 may be changed by adjusting lengths L1 and L2 of forward arms 110 and 114 with respect to rear arms 112 and 116. For example, the extent of the scissor-like motion of rear arms 112 and 116 may be the product of the ratio of L1/L2 multiplied by the length L1 of forward arms 110 and 114. The ratio of L1 to L2 may also determine a multiplication factor that is to be applied to the displacement reading of magnetic positional sensor 158. In some embodiments, the lengths L1 and L2 of forward arms and rear arms (with respect to serpentine member 106) may be adjusted to produce a mechanical multiplication factor (e.g., L1/L2) greater than unity of scissor-like motion of rear arms (e.g., rear arms 112 and 116) may be used to increase the resolution of the sensor. For example, sensor reading may be multiplied by the distance ratio L1/L2 in relation to the scissor-like movement of forward arms (e.g., forward arms 110 and 114). A mechanical multiplication factor L1/L2 smaller than unity may decrease the resolution of the magnetic positional sensor. A design where L1<L2 may be useful if the resolution of the sensor is exceeds requirements thereby achieving greater mechanical range of measurement (e.g., for fast growing plants).

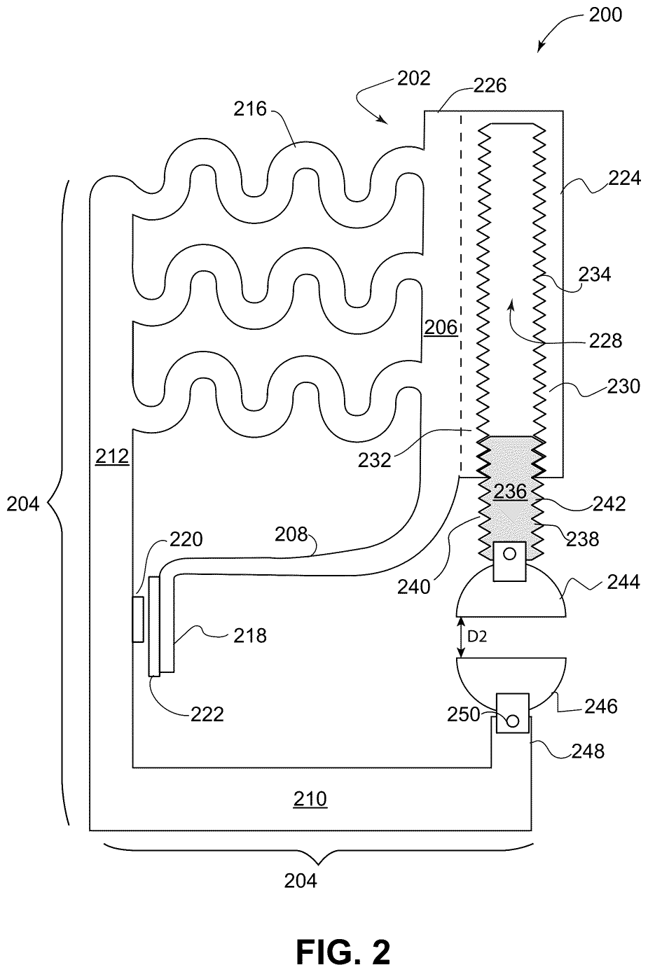

FIG. 2 illustrates a profile view of dendrometer assembly 200, in accordance with at least one embodiment. Dendrometer assembly 200 comprises a unitary frame body comprising frame member 202 and frame member 204. The unitary frame body is contiguous, whereby all members are formed as a single unit, using an additive or subtractive manufacturing process. All members may be made from the same material. For example, dendrometer assembly 200 comprises a carbon fiber composite. Frame member 202 comprises forward arm 206 that is contiguous with rear arm 208. In some embodiments, forward arm 206 extends in a substantially orthogonal sense with respect to rear arm 208. Frame member 204 comprises forward arm 210 and rear arm 212. In some embodiments, forward arm 210 is substantially perpendicular to rear arm 212. Frame member 204 provides principal mechanical support for dendrometer assembly 200. Frame member 202 and frame member 204 are coupled through serpentine member 214. In some embodiments, serpentine member 214 comprises one or more serpentine structures 216 that extend substantially orthogonally with respect to frame members 202 and 204. In at least one example, serpentine structures 216 may provide a flexible nonrigid structural member that is extensible and compressible within dendrometer assembly 200, allowing relative movement between frame members 202 and 204 by small forces as described below. Serpentine structures 216 are two-dimensional springs, where the spring constant is adjustable. For example, the width of serpentine structures 216 may be adjusted, as well as the composition of the material composing serpentine structures 216, to have a relatively loose spring constant so that minimal force may be applied to a fruit held by clamp members (see below).

Relative motion of frame members 202 and 204 is accomplished by a substantially linear vertical motion (in the z-direction) of frame member 202 relative to frame member 204. In some embodiments, a magnet 222 is attached to distal end 218 of rear arm 208 (of frame member 202). In some embodiments, a magnetic positional sensor 220 is attached to rear arm 212, whereby magnetic positional sensor 220 is positioned adjacent to magnet 222. Relative motion between frame members 202 and 204 cause relative motion between magnet 222 and magnetic positional sensor 220. The relative motion is detected by magnetic positional sensor 220. For example, magnetic positional sensor may comprise a hall effect sensor that is sensitive to small changes (sub-micron) in the magnetic field from magnet 222. In some embodiments, frame member 202 moves substantially upward (in the z-direction), causing magnetic positional sensor 220 to move relative to magnet 222. The magnetic field experienced by magnetic positional sensor 220 changes with small changes in position, and this change in the relative position of magnet 222 is sufficient to be detected by magnetic positional sensor 220. For example, magnetic positional sensor 220 may be capable of detecting sub-micron changes in the relative position of magnet 222.

In some embodiments, frame member 202 carries toothed socket 224 at distal end 226, whereby toothed socket 224 is unitary with forward arm 206 of frame member 202. Toothed socket 224 comprises slot 228, having two opposing sidewalls 230 and 232 that extend through the thickness (extending in the y-direction) of toothed socket 224. Sidewalls 230 and 232 are serrated, whereby the serrations are manifested as teeth 234. The pitch of teeth 234 may be adjusted to allow fine positioning of toothed peg 236. Toothed peg 236 has opposing serrated sidewalls 238 and 240, which have teeth 242. For example, teeth 242 of toothed peg 236 mesh with teeth 234 of toothed socket 224, thereby permitting fine adjustments of the position of toothed peg 236 relative to forward arm 210 of frame member 204, to adjust the distance D2 between upper clamp member 244 and lower clamp member 246.

In some embodiments, upper clamp member 244 is attached to toothed peg 236. Lower clamp member 246 is attached to distal end 248 of forward arm 210 via pin 250 on distal end 248. In the illustrative embodiment, upper clamp member 244 and lower clamp member 246 have a hemispherical form factor. In this manifestation, upper and lower clamp members 244 and 246, respectively, are configured to fit around a round fruit. Serpentine structures 216 may have spring constants adjusted to permit reaction to small forces exerted by a growing fruit, for example, held between upper clamp member 244 and lower clamp member 246.

FIG. 3A illustrates an end-on profile view oriented in the x-z plane of lower clamp member 148, in accordance with some embodiments. By symmetry, upper clamp member 144 may be represented in FIG. 3A. Lower (or upper) clamp member 148 (144) comprises trough 156, which extends in the y-direction (e.g., above and below the plane of the figure). Trough 156 may be configured for tree limb measurements. In some embodiments, trough 156 is bonded to plates 300, one of which is shown in the end-on view of lower clamp member 148. Plates 300 extend below trough 156 and are configured for attachment to forward arms 114 or 210 of dendrometer assemblies 100 or 200, respectively. A second plate 300 is hidden in the figure but shown in FIG. 3B. Plates 300 comprise hole 154, which is configured to pass a pin for attachment to forward arm 114 of dendrometer assembly 100 or forward arm 210 of dendrometer assembly 200, such as pin 152 (FIG. 1) or pin 250 (FIG. 2).

FIG. 3B illustrates a frontal view oriented in the y-z plane of lower clamp member 148, in accordance with some embodiments. Here, trough 156 is shown frontally as having flat walls extending lengthwise in the y-direction. The length of trough 156 may be slightly more than the thickness of the forward arm (e.g., forward arm 114, FIG. 1), to several times the thickness of the forward arm.

FIG. 3C illustrates a frontal view oriented in the y-z plane of lower clamp member 246, in accordance with some embodiments. By symmetry, upper clamp member 244 is also described in FIG. 3C. Lower (upper) clamp member 246 (244) has a hemispherical cup 306, configured to hold on a round fruit of a certain size that may be approximately the diameter of hemispherical cup 306. Plates 310 extend vertically below hemispherical cup 306 and may span the thickness of forward arms 114 or 210 of dendrometer assemblies 100 or 200, respectively. FIG. 3D illustrates a side profile view oriented in the x-z plane of lower clamp member 246, in accordance with some embodiments. Plates 310 are shown to comprise holes 154, configured to attach lower clamp member 246 or upper clamp member 244 to forward arms of dendrometer assemblies 100 or 200.

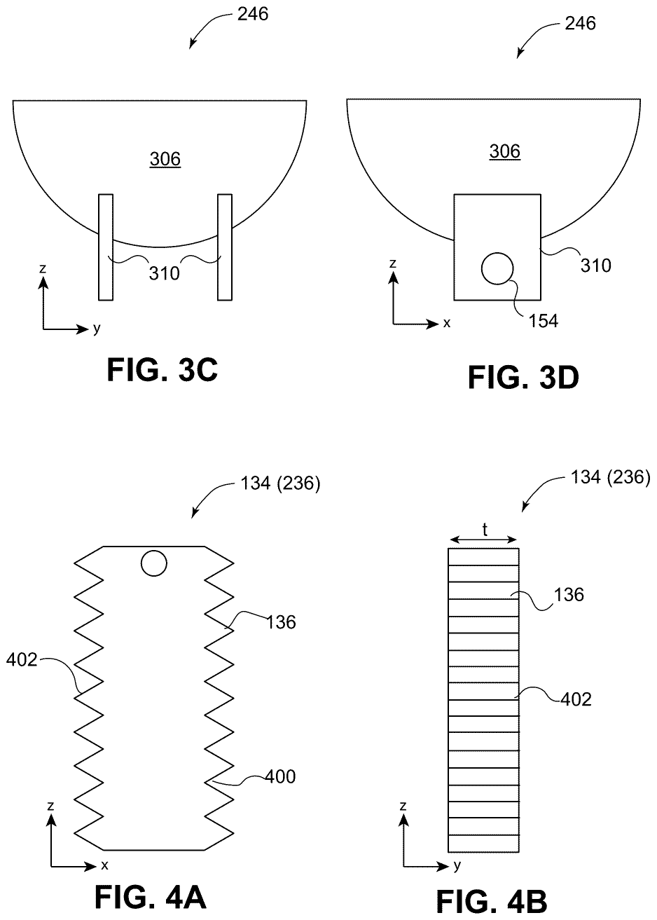

FIG. 4A illustrates a frontal profile view in the x-z plane of toothed peg 134 or 236, in accordance with some embodiments. Toothed peg 134 comprises opposing serrated sidewalls 400 and 402. Serrations are teeth 136 that are configured to mesh with teeth (e.g., teeth 132) of toothed sockets 118 or 224 of dendrometer assemblies 100 or 200, respectively. Teeth 136 have a pitch that may be adjustable to coarsen or refine accuracy of placement of toothed peg within toothed socket 118 or 224. Toothed peg 134 or 236 may insert toothed sockets 118 or 224, respectively, by pressing into slots (e.g., slot 122).

FIG. 4B illustrates a side profile view in the y-z plane of toothed peg 134 or 236, in accordance with some embodiments. Serrated sidewall 402 is shown in the figure, revealing teeth 136. Teeth 136 are triangular-shaped, but in some embodiments may also be round. In some embodiments, toothed peg 134 (236) has an extruded profile with a thickness t.

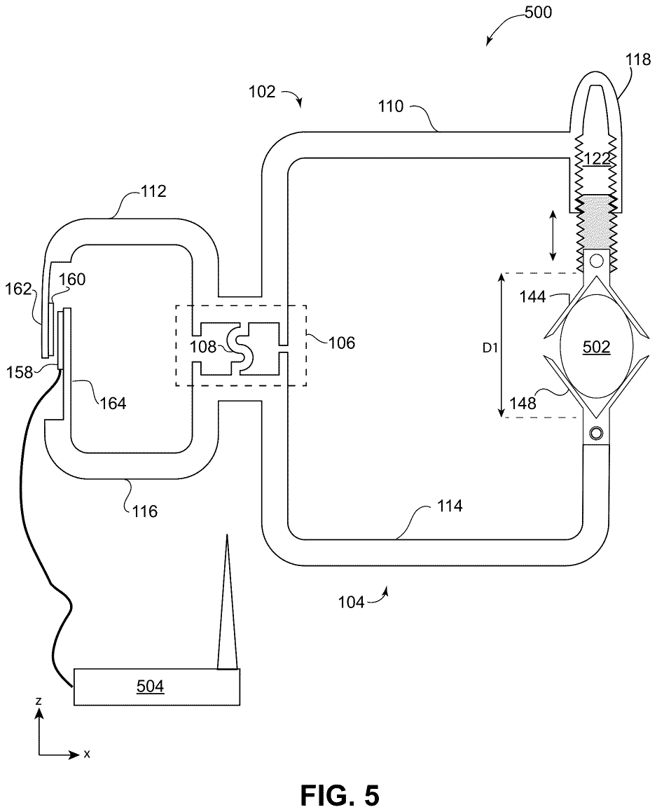

FIG. 5 illustrates a system 500 comprising dendrometer assembly 100, in accordance with some embodiments. In system 500, dendrometer assembly 100 is attached to limb 502 of a tree or bush. Upper clamp member 144 may be adjusted to form a tight fit around limb 502 with lower clamp member 148. Upper clamp member 144 is attached to toothed peg 134. The adjustment of a distance D1 may be made by finding a suitable position along toothed socket 118 whereby dendrometer assembly 100 may be securely held by limb 502 and pressing toothed peg 134 into slot 122 at that position. Dendrometer assembly 100 may be suspended from limb 502.

As limb 502 expands due to daily watering or growth, for example, frame members 102 and 104 tilt about serpentine member 106, which provides a fulcrum or pivot point. Distal ends 162 and 164 of rear arms 112 and 116, respectively, move relative to each other, such that magnet 160 slides past magnetic positional sensor 158 due to the scissor-like motion of rear arms 112 and 116. Small displacements of magnet 160 relative to magnetic positional sensor 158 are detectable by the sensor, with a resolution as small as 0.5 microns. This resolution may be changed by adjusting lengths L1 and L2 of forward arms 110 and 114 with respect to rear arms 112 and 116. The ratio of L1 to L2 determines a multiplication factor that is to be applied to the displacement reading of magnetic positional sensor 158. In some embodiments, the lengths L1 and L2 of forward arms and rear arms (with respect to serpentine member 106) may be adjusted to produce a mechanical multiplication factor (L1/L2) of scissor-like motion of rear arms (e.g., rear arms 112 and 116) in relation to the scissor-like movement of forward arms (e.g., forward arms 110 and 114). A mechanical multiplication factor greater than unity may increase the resolution of the magnetic positional sensor.

In some implementations, multiple dendrometer assemblies 100 may be deployed in an agricultural field. Individual dendrometers may be monitored remotely by transmission of telemetric data. In some embodiments, magnetic positional sensor 158 is coupled to a telemetry transmitter 504. For example, a LoRa™ telemetry system may be employed. Telemetry transmitter 504 may transmit on the 915 MHz ISM (industrial, scientific and medical) band (the 915 MHz ISM band is restricted to the International Telecommunications Union (ITU) Region 2, which includes the United States), for example. A telemetry receiver (not shown) may be deployed within the same field, receiving telemetry signals from the individual dendrometers via telemetry transmitters 504. In some embodiments, telemetry transmitter 504 is attached to frame member 104 at a suitable position, or on distal end 164, where it may be packaged with magnetic positional sensor 158 as an integrated circuit.

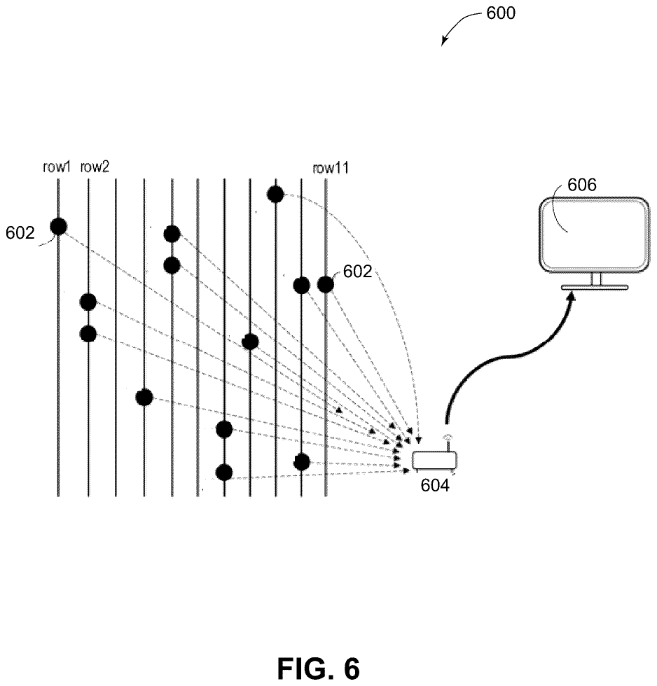

FIG. 6 illustrates sensor network 600 that the dendrometer uses to transfer data, in accordance with some embodiments. Sensor network 600 illustrates a plurality of dendrometer nodes 602 (e.g., system 500) attached to a sample of trunks per row in a field. In this example, 11 rows of plants are shown. Any number of dendrometer nodes 602 may be used and its data analyzed. In some embodiments, dendrometer nodes 602 are wirelessly connected to a central hub 604 through telemetry (indicated by dotted lines) that transfers data. Central hub 604 can be a cloud, server, computer, etc. In some embodiments, processed data from central hub 604 is displayed or reported on display 606.

Display 606 represents hardware (e.g., display devices) and software (e.g., drivers) components that provide a visual and/or tactile display for a user to interact with controller hub 604. Display 606 includes a display interface which includes the particular screen or hardware device used to provide a display to a user. In one embodiment, the display interface includes logic to perform at least some processing related to the display. In one embodiment, display 606 includes a touch screen (or touch pad) device that provides both output and input to a user. In various embodiments, the data from dendrometer nodes 602 is collected in real-time and processed as data arrives and is then displayed on display 606. In some embodiments, a mobile application can be used to access data from central hub 604. In some embodiments, a function of central hub 604 is implemented by mobile phone or a mobile processing device.

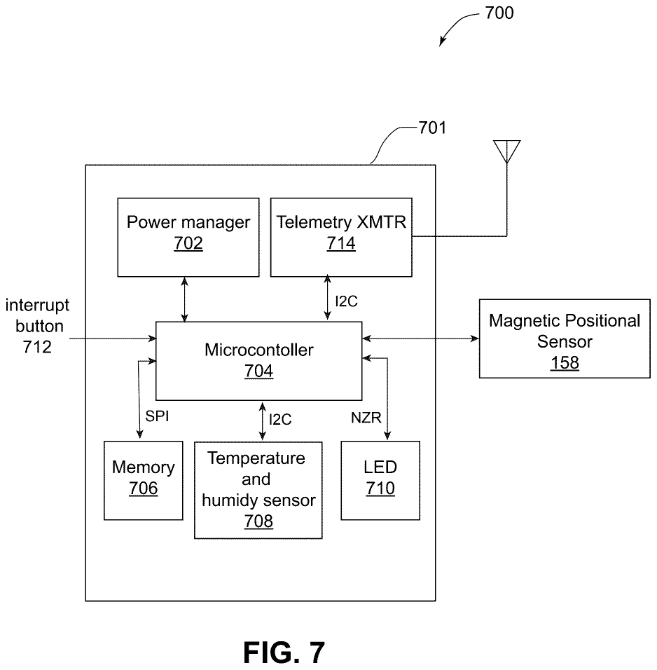

FIG. 7 illustrates an electronic system 700 with a schematic of a data logger for a magnetic positional sensor (e.g., magnetic positional sensor 158) and a light emitting diode indication system (LED indication system 710), in accordance with some embodiments. In some embodiments, computer system 700 includes one or more which is communicatively coupled to magnetic sensor 158 or 220, for example. In some embodiments, the one or more processors may be housed in waterproof box 701, which includes power manager 702, microcontroller 704, memory 706, temperature and humidity sensor 708, and/or and LED indication system 710. These various components in waterproof box 701 may include other components including an audio subsystem, a display subsystem, an I/O controller, connectivity, and peripheral connections.

In some embodiments, power manager 702 manages battery power usage, charging of the battery, and features related to power saving operation. In some embodiments, power manager 702 controls the power consumption of microcontroller 704 and other components. For example, power manager 702 can clock gate, power gate, or apply any other power management techniques. In some embodiments, power manager 702 is operable to datalog and time keep the various sensors coupled to dendrometer assemblies 100 or 200. In some embodiments, magnetic positional sensor 158, LED indication system 710, interrupt button 712, and temperature and humidity sensor 708 are powered through power manager 702, which acts as a relay that turns the power on and off to the sensors to conserve battery. While not shown, in some embodiments, a printed circuit board is provided, which breaks out the connections to standard JST wire ports that can be connected to the sensors.

In some embodiments, microcontroller 704 can include one or more physical devices, such as microprocessors, graphics processor, accelerator, inference logic, computational processor, application processors, microcontrollers, programmable logic devices, or other processing means. The processing operations performed by microcontroller 704 include the execution of an operating platform or operating system on which applications and/or device functions are executed. The processing operations include operations related to I/O (input/output) with a human user or with other devices, operations related to power management, and/or operations related to connecting waterproof box 701 to another device. The processing operations may also include operations related to audio I/O and/or display I/O. In some embodiments, microcontroller 704 executes the scheme of analyzing or processing electrical signals from magnetic positional sensor 158. In some embodiments, magnetic positional sensor 158 is coupled to microcontroller 704 via a serial bus. In some embodiments, microcontroller 704 can be reset, powered on, or interrupted using interrupt button 712. In some embodiments, microcontroller 704 communicates with memory 706 using a serial peripheral interface (SPI). In some embodiments, microcontroller 704 communicates with memory 706 using an I2C interface. In some embodiments, microcontroller 704 communicates with memory 706 using non-return-to-zero (NRZ) signal interface.

In some embodiments, memory 706 includes memory devices for storing information. Memory 706 can include nonvolatile (state does not change if power to the memory device is interrupted) and/or volatile (state is indeterminate if power to the memory device is interrupted) memory devices. Examples of nonvolatile memory include flash memory, magnetic memory, resistive memory. Examples of volatile memory include static random-access memory, dynamic random-access memory, etc. Memory 706 can store application data, user data, documents, or other data, as well as system data (whether long-term or temporary) related to the execution of the applications and functions of the computing system.

Elements of embodiments are also provided as a machine-readable medium (e.g., memory 706) for storing the computer-executable instructions (e.g., instructions to implement any other processes discussed herein). The machine-readable medium (e.g., memory 706) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, audio subsystem represents hardware (e.g., audio hardware and audio circuits) and software (e.g., drivers, codecs) components associated with providing audio functions to the computing system. Devices for such functions can be integrated into the computing system or connected to the computing system. Audio functions can include speaker and/or headphone output, as well as microphone input. In some embodiments, a user interacts with the computing system by providing audio commands that are received and processed by microcontroller 704.

In some embodiments, the computing system including connectivity can include multiple different types of connectivity. The computing system may include cellular connectivity and wireless connectivity. Cellular connectivity refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) refers to wireless connectivity that is not cellular and can include personal area networks (such as Bluetooth, Near Field, etc.), local area networks (such as Wi-Fi), and/or wide area networks (such as LTE), or other wireless communication.

In some embodiments, LED indication system 710 is implemented to easily check that dendrometer assembly 100 is actively collecting data. In some embodiments, LED indication system 710 comprises an interrupt button 712, LED indication system 710 may comprise an LED, and an LED plug, for example. When interrupt button 712 is pushed, microcontroller 704 or any other suitable logic may check the distance between magnet 160 and magnetic positional sensor 158 to see if it is still within a required range (e.g., a range of 0.2 mm to 0.4 mm) as well as if the magnet (e.g., magnet 160) is parallel with magnetic positional sensor 158. If it is, LED indication system 710 will turn green for a few seconds; this indicates that dendrometer assembly 100 is still accurately recording data. If the LED of LED indication system 710 turns red, something may have caused the magnet 160 to shift relative to magnetic positional sensor 158, in which case the data may no longer be valid during the previous testing period (when looking at the data, an operator may likely be able to see a jump when the misalignment event occurred). In some cases, the LED of LED indication system 710 may appear yellow; this means that the alignment is still in range but is on the very edge. This could impact the precision of the measurements. In this case it may be recommended that the same procedures for adjustment be followed as when the LED of LED indication system 710 is red. However, if yellow, the data trends can be expected to still be valid. While LED indication system 710 functions are explained with reference to a single LED with three colors, multiple LEDs with any number of colors may be used to conveying information about dendrometer assembly 100.

In some embodiments, magnetic positional sensor 158 communicates with microcontroller 704 through a serial communication bus. The serial communication bus is bit-banged into a serial value that can be converted into a distance or displacement measurement, in accordance with some embodiments. In some embodiments, if magnet 160 is held parallel to magnetic positional sensor 158 within a distance (e.g., 0.2 mm to 0.4 mm), magnetic positional sensor 158 may be able to detect magnet 160 and the distance traveled since the last measurement. In some embodiments, microcontroller 704 turns on when the power source is plugged in. In some embodiments, microcontroller 704 enters autonomous operation once magnet 160 (or magnet 222) and magnetic positional sensor 158 (or magnetic positional sensor 220) are properly aligned. In various embodiments, displacement measurements are based on serial values upon device initialization and/or installation. In some embodiments, data values for time, temperature, humidity, serial value, displacement, and vapor pressure deficit are recorded locally in memory 706 and transmitted wirelessly to telemetry transmitter 714 (e.g., telemetry transmitter 504) via its antenna.

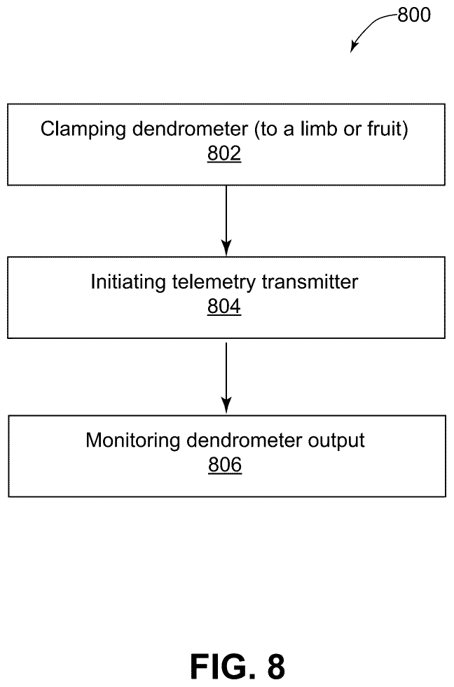

FIG. 8 illustrates a flow chart 800 for operating a dendrometer assembly 100 or 200, according to embodiments disclosed herein. In some embodiments, flow chart 800 applies to operation of dendrometer assembly 100 and dendrometer assembly 200.

At operation 802, the disclosed dendrometer (e.g., dendrometer assemblies 100 or 200), may be attached to an object (e.g., tree limb or fruit). The attachment procedure may include clamping to a limb or a tree, for example, a branch or trunk, via clamp members (e.g., upper clamp member 144 and lower clamp member 148). The clamp members may be adjusted to securely attach by positioning the peg (e.g., toothed peg 134), and therefore the upper clamp member, along the serrated slot of a toothed socket, such as toothed socket 118. The peg may be adjusted by pushing it out and re-inserted into the slot of the toothed socket. The serrations of both the peg and the toothed socket prevent the peg from slipping within the slot, and thus securely holding the upper clamp at a suitable distance (e.g., distance D1, FIG. 1 from the lower clamp member without needing readjustment. The distance may be adjusted to fit about a particular diameter of a limb or fruit specimen.

In some embodiments, the clamp members may be V-shaped troughs, for example, lower clamp member 148 shown in FIGS. 3A and 3B, or hemispherical cups 306, as shown in FIGS. 3C and 3D. The latter may be configured to fit around a round fruit. The size of hemispherical cups depends on the size of fruit, thus the dendrometer may be accompanied by a selection of hemispherical clamp members for different size fruits. In addition to the size of clamp members, the unitary frame body of the dendrometer may also be dimensioned for different sized fruits or limbs. For example, a dendrometer, for example, dendrometer assembly 100 or 200, dimensioned for measuring grapes or berries may generally be physically smaller than an identical dendrometer design (e.g., dendrometer assemblies 100 or 200) dimensioned for measuring a grapefruit or similar sized fruit.

Similarly for measurement of limbs, a V-shaped trough clamp member (e.g., upper and lower clamp members 144 and 148, respectively) may be sized for the general size of the limb or limbs to be measured. The size of trough 156 may be dimensioned accordingly. As noted above, fine adjustments of upper clamp members may be performed by suitable positioning of toothed peg (e.g., toothed peg 134 or 236) within, for example, slot 122 of toothed socket 118. In some embodiments, serrations of teeth (e.g., teeth 136 or 242) of a toothed socket (e.g., toothed sockets 118 or 224) can be configured for large or small adjustments in the position of the toothed peg. A user may adjust the height of upper clamp member relative to the lower clamp member to securely clamp the dendrometer to a limb or fruit by removing the toothed peg from the toothed socket and finding a more suitable position. This position can be securely held by the serrated teeth (e.g., teeth 136) of both the toothed peg (e.g., toothed peg 134) and the sidewalls (e.g., sidewalls 128 and 130 of slot 122, toothed socket 118, FIG. 1), providing a tight fit and preventing slippage of the toothed peg. The pitch of the serrated teeth may be configured to provide a fine adjustment of distance, such as distance D1, between upper and lower clamp members. For delicate fruits, this feature is important. A fine adjustment capability of the toothed peg may aid in avoiding excess strain on the fruit due to an excessively tight fitting of clamp members.

At operation 804, the telemetry transmitter may be activated once the dendrometer is physically installed. As an example, interrupt button 712 may be pushed to zero by the magnetic position sensor. Any changes in relative position of magnet and magnetic positional sensor (e.g., magnetic positional sensor 158) may be detected by the latter, responding to small changes of magnetic field due to displacement of magnet 160 relative to magnetic positional sensor 158, and configured to report data with a submicron resolution. In some embodiments, the data are output as a digital pulse-width modulation (PWM), where the width of pulses may be calibrated to correspond to distance measurements. Using a PWM scheme avoids the need for the intermediary of an analog to digital converter (ADC), which uses a resistor ladder to convert an analog voltage to a digital voltage. As the resistances are somewhat temperature dependent, the accuracy of the conversion may change in the field. In contrast, a PWM generator circuitry may be temperature compensated. As an example, magnetic positional sensor 158 is a small (e.g., <2 cm) surface mount or through-hole hall-effect sensor chip. The PWM generator circuitry may be integrated with the sensor circuitry. The Hall-effect sensor may be sensitive to magnetic flux density (e.g., B) fields as small as 10 milliTesla (mT), or 100 gauss. The displacement of the PWM data may be converted directly to binary data by an on-board processor, such as microprocessor 704 (FIG. 7). Displacement measurements may be transmitted wirelessly to a receiving station by telemetry through a telemetry transmitter, such as telemetry transmitter 504 (FIG. 5).

Motion of the magnet relative to the magnetic positional sensor is due to relative movement of frame members (e.g., frame members 102 and 104). In dendrometer assembly 100 for example, the motion is scissor-like, whereby a fulcrum or pivot point between forward arms and rear arms (of frame members) is provided by serpentine member 106, which function by the elastic movement of serpentine structures 108. As a fruit expands, for example, forward arms open, while rear arms close. The spring constant of serpentine structures 108 may be configured to permit movement of frame members without placing strain on a delicate fruit to which the dendrometer is attached as the fruit expands. In some embodiments, the lengths L1 and L2 of forward arms and rear arms (with respect to serpentine member 106) may be adjusted to produce a mechanical multiplication factor (L1/L2) of scissor-like motion of rear arms (e.g., rear arms 112 and 116) in relation to the scissor-like movement of forward arms (e.g., forward arms 110 and 114). A mechanical multiplication factor greater than unity may increase the resolution of the magnetic positional sensor.

At operation 806, dendrometer output may be measured by wireless monitoring via a telemetry system as described above for FIG. 6. In an example, movement of magnet 160 relative to magnetic positional sensor 158 may be detected by the latter device and converted to binary data by an on-board microprocessor and wireless transmitted to a telemetry receiving station. For example, such a wireless telemetry system may be a LoRa™ system, where individual telemetry transmitters may be connected in an agricultural or horticultural field using a wireless area network (WAN) for short-and long-range telemetry (for example, LoRaWAN™). A telemetry transmitter module may be an integrated circuit device (e.g., ASR6601 telemetry transmitter module) that transmits on the 915 MHz ISM (industrial, scientific and medical telemetry band, 902-928 MHz, ITU region 2) band with a power level of approximately 160 mW, or on 410-525 MHz (approximately 100 mW) with a SX 1278 transmitter module (ITU Region 1, which includes Europe and Africa). In a further example, as a receiving WAN station, an ASR6601915 MHz ISM or an RFM9W 915 MHz ISM transceiver module (e.g., for use in ITU region 2) or a LLCC68 433 MHz (e.g., for use in ITU Region 1) transceiver module may be employed. The WAN system may be capable of line-of-sight and quasi-line-of-sight (e.g., 433 MHz) wireless telemetry networking over 5 km or 6 km distances. A gateway station (e.g., a LoRaWAN™ gateway) may transfer the data to an internet of things (IoT) device which may then be internet enabled. While the LoRa™ (Long Range Telemetry) telemetry system, which employs a proprietary CSS (chirp spread spectrum) or FSK (frequency shift keying) data modulation scheme on the RF carrier for long range RF communication using low power, is used for exemplary purposes here, other modular wireless telemetry technologies may also be employed and used in a similar fashion.

The data may be displayed, for example, on display 606 in FIG. 6, which may be a computer screen in a field station or on a remote computer through the internet. Data may be stored in several formats and converted to hard copy text formats for generation of reports.

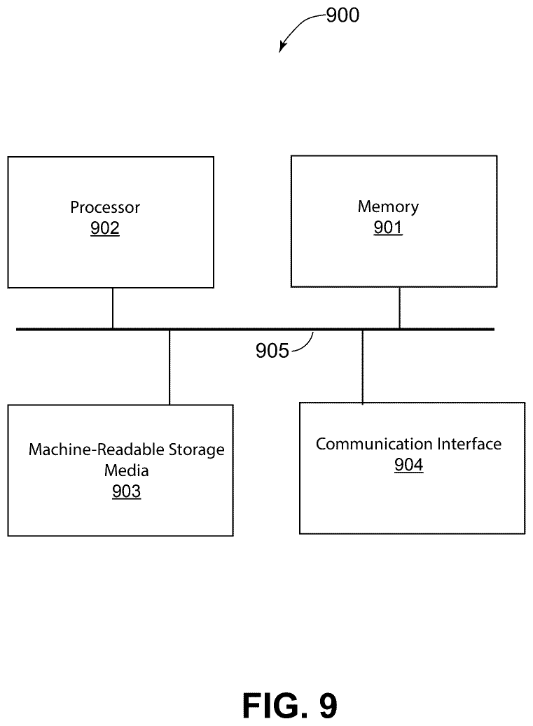

FIG. 9 illustrates a processor system 900 with a machine-readable storage medium having machine-readable instructions that when executed cause microcontroller 704 to execute machine-readable instructions according to the method summarized by flow chart 800, in accordance with at least one embodiment. In at least one embodiment, processor system 900 comprises memory 901, processor 902, machine-readable storage medium 903 (also referred to as tangible machine-readable medium), communication interface 904 (e.g., wireless or wired interface), and network bus 905 coupled together as shown. In at least one embodiment, processor system 900 may be part of a computing system associated with microcontroller 704. In at least one embodiment, processes described herein may be stored in machine readable medium 903 as computer-executable instructions. In at least one embodiment, a machine-readable storage medium may be random access memory (RAM).

In at least one embodiment, processor 902 is a digital signal processor (DSP), an application specific integrated circuit (ASIC), a general-purpose central processing unit (CPU), or a low power logic implementing a simple finite state machine to perform various processes described herein. In at least one embodiment, processor 902 is equivalent to microcontroller 704 shown in FIG. 7.

In at least one embodiment, various logic blocks of processor system 900 are coupled together via network bus 905. Any suitable protocol may be used to implement network bus 905. In at least one embodiment, machine-readable storage medium 903 includes instructions (also referred to as program software code/instructions) for actuating valves of the process gas delivery system, and heating portions of delivery lines, for example, coded into software stored in machine-readable storage medium 903.

In at least one embodiment, machine-readable storage media 903 is a machine-readable storage media with instructions for operation of processor 902. In at least one embodiment, machine-readable medium 903 has machine-readable instructions, that when executed, cause processor 902 to perform the method discussed herein

In at least one embodiment, program software code/instructions associated with various embodiments may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, program software code/instructions associated with processes of various embodiments are executed by processor system 900.

In at least one embodiment, machine-readable storage media 903 is a computer executable storage medium. In at least one embodiment, program software code/instructions associated with various embodiments are stored in computer executable storage medium 903 and executed by processor 902. Here, computer executable storage medium 903 is a tangible machine-readable medium 903 that can be used to store program software code/instructions and data that, when executed by a computing device, causes one or more processors (e.g., processor 902) to perform a process.

In at least one embodiment, tangible machine-readable medium 903 may include storage of executable software program code/instructions and data in various tangible locations, including for example, ROM, volatile RAM, non-volatile memory, and/or cache, and/or other tangible memory as referenced in present application. Portions of this program software code/instructions and/or data may be stored in any one of these storage and memory devices. In some embodiments, program software code/instructions can be obtained from other storage, including, e.g., through centralized servers or peer to peer networks and the like, including the Internet. Different portions of software program code/instructions and data can be obtained at different times and in different communication sessions or in the same communication session.

In at least one embodiment, software program code/instructions associated with various embodiments can be obtained in their entirety prior to execution of a respective software program or application. Alternatively, portions of software program code/instructions and data can be obtained dynamically, e.g., just in time, when needed for execution. Alternatively, some combination of these ways of obtaining software program code/instructions and data may occur, e.g., for different applications, components, programs, objects, modules, routines, or other sequences of instructions or organization of sequences of instructions, by way of example. Thus, it may not be required that data and instructions be on a tangible machine-readable medium 903 in entirety at a particular instance of time.

In at least one embodiment, tangible machine-readable medium 903 include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMs), Digital Versatile Disks (DVDs), etc.), among others. In at least one embodiment, software program code/instructions may be temporarily stored in digital tangible communication links while implementing electrical, optical, acoustical, or other forms of propagating signals, such as carrier waves, infrared signals, digital signals, etc. through such tangible communication links.

In some instances, well-known methods and devices are shown in block diagram form, rather than in detail, to avoid obscuring at least one embodiment. Reference throughout this specification to “an embodiment,” “one embodiment,” “in at least one embodiment,” or “some embodiments” means that a particular feature, structure, function, or characteristic described in connection with embodiment is included in at least one embodiment. Thus, appearances of phrase “in an embodiment,” “in at least one embodiment,” or “in one embodiment” or “some embodiments” in various places throughout this specification are not necessarily referring to same embodiment of disclosure. Furthermore, particular features, structures, functions, or characteristics may be combined in any suitable manner in one or more embodiments. For example, a first embodiment may be combined with a second embodiment anywhere particular features, structures, functions, or characteristics associated with two embodiments are not mutually exclusive.

As used in herein, singular forms “a,” “an,” and “the” are intended to include plural forms as well, unless context clearly indicates otherwise. It will also be understood that term “and/or” as used herein refers to and encompasses all possible combinations of one or more of associated listed items.

Here, “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical, electrical or in magnetic contact with each other, and/or that two or more elements co-operate or interact with each other (e.g., as in a cause an effect relationship). Coupled may also have the meaning of non-mechanical contact or connection. Coupling may also have the meaning of thermal connectivity, where one object may be a heat source and another object may be a heat sink, either in thermal equilibrium with each other or subject to a common conductive, convective or radiative heat flow between them; electrically coupled, where objects may be connected electrically in an electric or electronic circuit and a current flow may be induced by application of a voltage between the electrically interconnected objects or by an electric field between mechanically coupled or isolated objects; magnetically, where two mechanically coupled or isolated objects mutually share a common magnetic field flux; and fluidically, where objects such as vessels and conduits may share a common gas or liquid fluid that is static or flowing.

Here, a device that is “configured to” perform a task or function may be configured (e.g., programmed and/or hardwired) at a time of manufacturing by a manufacturer to perform the function. In at least one example, the device may be configurable (or reconfigurable) by a user after manufacturing to perform the function and/or other additional or alternative functions. In at least one example, the configuring may be through firmware and/or software programming of the device, through a construction and/or layout of hardware components and interconnections of the device, or a combination thereof.

Here, “between” may be employed in context of z-axis, x-axis or y-axis of a device. A material that is between two other materials may be in contact with one or both of those materials. In another example, a material that is between two or other material may be separated from both of other two materials by one or more intervening materials. A material “between” two other materials may therefore be in contact with either of other two materials. In another example, a material “between” two other materials may be coupled to other two materials through an intervening material. A device that is between two other devices may be directly connected to one or both of those devices. In another example, a device that is between two other devices may be separated from both of other two devices by one or more intervening devices.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” second material if device is oriented upside-down relative to context of figure provided. Similar distinctions are to be made in context of component assemblies.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one embodiment, such variation is no more than +/−10% of referred value.

In the following paragraphs, examples are provided that illustrate various embodiments. Here, examples can be combined with other examples. As such, various embodiments can be combined with other embodiments without changing scope of disclosure.

Example 1 is a dendrometer, comprising a first frame member; a second frame member coupled to the first frame member by one or more serpentine members, wherein the one or more serpentine members extend between the first frame member and the second frame member, wherein the one or more serpentine members are nonrigid such that the second frame member is movable relative to the first frame member; a toothed socket on an end of the first frame member; a magnet attached to the first frame member; and a positional sensor attached to the second frame member, wherein the positional sensor is adjacent to the magnet.

Example 2 is a dendrometer as in any of the examples, in particular example 1, wherein a clamp member is attached to the second frame member.

Example 3 is a dendrometer as in any of the examples, in particular example 2, wherein the toothed socket comprises a slot that extends within the toothed socket along a long axis of the toothed socket from a first end to a second end, wherein the first end is open, wherein the slot has two opposing sidewalls, and wherein a first plurality of teeth is within a first sidewall and a second plurality of teeth is within a second sidewall of the two opposing sidewalls.

Example 4 is a dendrometer as in any of the examples, in particular example 3, further comprising a detachable peg having a third sidewall and an opposing fourth sidewall, wherein a third plurality of teeth is within the third sidewall and a fourth plurality of teeth is within the opposing fourth sidewall, wherein the detachable peg is configured to engage the toothed socket by insertion into the slot, and wherein the third plurality of teeth is configured to engage with the first plurality of teeth and the fourth plurality of teeth is configured to engage with the second plurality of teeth.

Example 5 is a dendrometer as in any of the examples, in particular example 4, wherein the clamp member is a first clamp member, and where a second clamp member is attached to the detachable peg.

Example 6 is a dendrometer as in any of the examples, in particular example 5, wherein the first frame member comprises a first pivot point from which a first arm and a second arm extend in opposite directions, wherein the second frame member comprises a second pivot point from which a third arm and a fourth arm extend in opposite directions, and wherein the one or more serpentine members extend between the first pivot point and the second pivot point.

Example 7 is a dendrometer as in any of the examples, in particular example 6, wherein the second arm of the first frame member is opposite the fourth arm of the second frame member, and wherein the magnet is attached to a first distal end of the second arm and the positional sensor is attached to a second distal end of the fourth arm, wherein the second arm and the fourth arm are shaped such that the magnet is adjacent to the positional sensor, and wherein a gap is between the magnet and the positional sensor.

Example 8 is a dendrometer as in any of the examples, in particular example 7, wherein, wherein the first arm of the first frame member is opposite the third arm of the second frame member, wherein the toothed socket is at a third distal end of the first arm, and the third arm is configured to attach the first clamp member at a fourth distal end, and wherein the third distal end is opposite the fourth distal end.

Example 9 is a dendrometer as in any of the examples, in particular example 8, wherein the first arm of the first frame member extends a first distance between the first pivot point and the third distal end, and the second arm of the first frame member extends a second distance between the first pivot point and the first distal end, such that a first relative motion between the second arm and the fourth arm is substantially equal to a product of a second relative motion between the first arm and the third arm multiplied by a ratio of the second distance to the first distance, and wherein the first relative motion is a first change in a third distance between the first distal end and the third distal end, and the second relative motion is a second change in a fourth distance between the second distal end and the fourth distal end.

Example 10 is a dendrometer as in any of the examples, in particular example 9, wherein the third arm of the second frame member is orthogonal to the fourth arm, wherein the one or more serpentine members extend between the fourth arm of the second frame member and the first arm of the first frame member.

Example 11 is a dendrometer as in any of the examples, in particular example 10, wherein the second arm of the first frame member is shaped such that the first distal end of the second arm is adjacent to a portion of the fourth arm of the second frame member.

Example 12 is a dendrometer as in any of the examples, in particular example 10, wherein the toothed socket extends along the first arm of the first frame member, and wherein an open end of the toothed socket faces the fourth distal end of the third arm of the second frame member.

Example 13 is a dendrometer as in any of the examples, in particular example 1, wherein the first frame member, the one or more serpentine members and the second frame member are contiguous members of a unitary body.

Example 14 is a system, comprising a dendrometer, wherein the dendrometer comprises: a first frame member; a second frame member coupled to the first frame member by one or more serpentine members, wherein the one or more serpentine members extend between the first frame member and the second frame member, wherein the one or more serpentine members are nonrigid (extensible and compressible) such that the second frame member is movable relative to the first frame member; a toothed socket on an end of the first frame member; a magnet attached to the first frame member; and a magnetic positional sensor attached to the second frame member, wherein the magnetic positional sensor is adjacent to the magnet; an electronic circuit package coupled to the magnetic positional sensor, wherein the electronic circuit package is attached to the second frame member; and a wireless telemetry transmitter coupled to the electronic circuit package.

Example 15 is a system as in any of the examples, in particular example 13, further comprising a toothed peg having a first sidewall opposing a second sidewall, wherein the first sidewall includes a first row of teeth and the second sidewall includes a second row of teeth, wherein a slot within the toothed socket has a third sidewall and an opposing fourth sidewall, the third sidewall having a third row of teeth and the opposing fourth sidewall having a fourth row of teeth, wherein the toothed peg is held within the slot of the toothed socket, and wherein the first row of teeth is engaged with the third row of teeth, and the second row of teeth is engaged with the fourth row of teeth.

Example 16 is a system as in any of the examples, in particular example 15, wherein the first frame member, the one or more serpentine members and the second frame member are contiguous members of a unitary body.

Example 17 is a system as in any of the examples, in particular example 16, wherein a first clamp member is attached to the toothed peg, and a second clamp member is attached to the second frame member.

Example 18 is a system as in any of the examples, in particular example 17, wherein the first clamp member and the second clamp member are configured for attachment to an object.

Example 19 is a system as in any of the examples, in particular example 15, wherein the electronic circuit package comprises a microprocessor a memory coupled to the microprocessor, a temperature sensor coupled to the microprocessor, a power manager coupled to the microprocessor, and a wireless telemetry transmitter coupled to the microprocessor and the power manager.

Example 20 is a method for operating a dendrometer, comprising attaching the dendrometer to an object, wherein the dendrometer comprises: a first frame member; a second frame member coupled to the first frame member by one or more serpentine members, wherein the one or more serpentine members extend between the first frame member and the second frame member, wherein the one or more serpentine members are nonrigid such that the second frame member is movable relative to the first frame member; a toothed socket on an end of the first frame member; a magnet attached to the first frame member; and a magnetic positional sensor attached to the second frame member, wherein the magnetic positional sensor is adjacent to the magnet; initiating a telemetry transmitter coupled to the magnetic positional sensor; and monitoring an output of the dendrometer.

Example 21 is a method as in any of the examples, in particular example 20, wherein attaching the dendrometer to the object comprises: placing a first clamp member and a second clamp member over the object; and adjusting a distance between the first clamp member and the second clamp member, wherein the first clamp member is attached to a toothed peg, and the toothed peg is inserted within the toothed socket.

Example 22 is a method as in any of the examples, in particular example 21, wherein the toothed peg is inserted within a serrated slot of the toothed socket, and wherein the toothed peg comprises opposing toothed sidewalls that mesh with a plurality of teeth of the serrated slot.

Example 23 is a method as in any of the examples, in particular example 20, wherein the first frame member, the one or more serpentine members and the second frame member are contiguous members of a unitary body.

Besides what is described herein, various modifications can be made to disclosed embodiments and embodiments thereof without departing from their scope. Therefore, illustrations of embodiments herein should be construed as examples, and not restrictive to scope of present disclosure.

What is claimed is:

1. A dendrometer, comprising:
a first frame member;
a second frame member coupled to the first frame member by one or more serpentine members, wherein the one or more serpentine members extend between the first frame member and the second frame member, wherein the one or more serpentine members are nonrigid such that the second frame member is movable relative to the first frame member;
a toothed socket on an end of the first frame member;
a magnet attached to the first frame member; and
a positional sensor attached to the second frame member, wherein the positional sensor is adjacent to the magnet.

2. The dendrometer of claim 1, wherein a clamp member is attached to the second frame member.

3. The dendrometer of claim 2, wherein the toothed socket comprises a slot that extends within the toothed socket along a long axis of the toothed socket from a first end to a second end, wherein the first end is open, wherein the slot has two opposing sidewalls, and wherein a first plurality of teeth is within a first sidewall and a second plurality of teeth is within a second sidewall of the two opposing sidewalls.

4. The dendrometer of claim 3, further comprising a detachable peg having a third sidewall and an opposing fourth sidewall, wherein a third plurality of teeth is within the third sidewall and a fourth plurality of teeth is within the opposing fourth sidewall, wherein the detachable peg is configured to engage the toothed socket by insertion into the slot, and wherein the third plurality of teeth is configured to engage with the first plurality of teeth and the fourth plurality of teeth is configured to engage with the second plurality of teeth.

5. The dendrometer of claim 4, wherein the clamp member is a first clamp member, wherein a second clamp member is attached to the detachable peg.

6. The dendrometer of claim 5, wherein the first frame member comprises a first pivot point from which a first arm and a second arm extend in opposite directions, wherein the second frame member comprises a second pivot point from which a third arm and a fourth arm extend in opposite directions, and wherein the one or more serpentine members extend between the first pivot point and the second pivot point.

7. The dendrometer of claim 6, wherein the second arm of the first frame member is opposite the fourth arm of the second frame member, and wherein the magnet is attached to a first distal end of the second arm and the positional sensor is attached to a second distal end of the fourth arm, wherein the second arm and the fourth arm are shaped such that the magnet is adjacent to the positional sensor, and wherein a gap is between the magnet and the positional sensor.

8. The dendrometer of claim 7, wherein the first arm of the first frame member is opposite the third arm of the second frame member, wherein the toothed socket is at a third distal end of the first arm, and the third arm is configured to attach the first clamp member at a fourth distal end, and wherein the third distal end is opposite the fourth distal end.

9. The dendrometer of claim 8, wherein the first arm of the first frame member extends a first distance between the first pivot point and the third distal end, and the second arm of the first frame member extends a second distance between the first pivot point and the first distal end, such that a first relative motion between the second arm and the fourth arm is substantially equal to a product of a second relative motion between the first arm and the third arm multiplied by a ratio of the second distance to the first distance, and wherein the first relative motion is a first change in a third distance between the first distal end and the third distal end, and the second relative motion is a second change in a fourth distance between the second distal end and the fourth distal end.

10. The dendrometer of claim 9, wherein the third arm of the second frame member is orthogonal to the fourth arm, wherein the one or more serpentine members extend between the fourth arm of the second frame member and the first arm of the first frame member.

11. The dendrometer of claim 10, wherein the second arm of the first frame member is shaped such that the first distal end of the second arm is adjacent to a portion of the fourth arm of the second frame member.

12. The dendrometer of claim 10, wherein the toothed socket extends along the first arm of the first frame member, and wherein an open end of the toothed socket faces the fourth distal end of the third arm of the second frame member.

13. The dendrometer of claim 1, wherein the first frame member, the one or more serpentine members and the second frame member are contiguous members of a unitary body.

14. A system, comprising:
a dendrometer, wherein the dendrometer comprises:
a first frame member;
a second frame member coupled to the first frame member by one or more serpentine members, wherein the one or more serpentine members extend between the first frame member and the second frame member, wherein the one or more serpentine members are nonrigid (extensible and compressible) such that the second frame member is movable relative to the first frame member;
a toothed socket on an end of the first frame member;
a magnet attached to the first frame member; and
a magnetic positional sensor attached to the second frame member, wherein the magnetic positional sensor is adjacent to the magnet;
an electronic circuit package coupled to the magnetic positional sensor, wherein the electronic circuit package is attached to the second frame member; and
a wireless telemetry transmitter coupled to the electronic circuit package.

15. The system of claim 14, wherein the first frame member, the one or more serpentine members and the second frame member are contiguous members of a unitary body.

16. The system of claim 14, further comprising a toothed peg having a first sidewall opposing a second sidewall, wherein the first sidewall includes a first row of teeth and the second sidewall includes a second row of teeth, wherein a slot within the toothed socket has a third sidewall and an opposing fourth sidewall, the third sidewall having a third row of teeth and the opposing fourth sidewall having a fourth row of teeth, wherein the toothed peg is held within the slot of the toothed socket, and wherein the first row of teeth is engaged with the third row of teeth, and the second row of teeth is engaged with the fourth row of teeth.

17. The system of claim 16, wherein a first clamp member is attached to the toothed peg, and a second clamp member is attached to the second frame member.

18. The system of claim 17, wherein the first clamp member and the second clamp member are configured for attachment to an object.

19. The system of claim 14, wherein the electronic circuit package comprises a microprocessor, a memory coupled to the microprocessor, a temperature sensor coupled to the microprocessor, and a power manager coupled to the microprocessor, and a wireless telemetry transmitter coupled to the microprocessor and the power manager.

20. A method for operating a dendrometer, comprising:
attaching the dendrometer to an object, wherein the dendrometer comprises:
a first frame member;
a second frame member coupled to the first frame member by one or more serpentine members, wherein the one or more serpentine members extend between the first frame member and the second frame member, wherein the one or more serpentine members are nonrigid such that the second frame member is movable relative to the first frame member;
a toothed socket on an end of the first frame member;
a magnet attached to the first frame member; and
a magnetic positional sensor attached to the second frame member, wherein the magnetic positional sensor is adjacent to the magnet;
initiating a telemetry transmitter coupled to the magnetic positional sensor; and
monitoring an output of the dendrometer.

21. The method of claim 20, wherein attaching the dendrometer to the object comprises:
placing a first clamp member and a second clamp member over the object; and
adjusting a distance between the first clamp member and the second clamp member, wherein the first clamp member is attached to a toothed peg, and the toothed peg is inserted within the toothed socket.

22. The method of claim 21, wherein the toothed peg is inserted within a serrated slot of the toothed socket, and wherein the toothed peg comprises opposing toothed sidewalls that mesh with a plurality of teeth of the serrated slot.

23. The method of claim 20, wherein the first frame member, the one or more serpentine members and the second frame member are contiguous members of a unitary body.
